(19) United States
(12) Patent Application Publication
(10) Pub. No.: US 2014/0217342 A1
(43) Pub. Date: Aug. 7, 2014

(54) VEHICLE WITH INTEGRAL TIRE JACKS

(71) Applicant: KING FAHD UNIVERSITY OF PETROLEUM AND MINERALS, Dhahran (SA)

(72) Inventors: MEHMET DONDURUR, CROFTON, MD (US); AHMET Z. SAHIN, DHAHRAN (SA)

(73) Assignee: KING FAHD UNIVERSITY OF PETROLEUM AND MINERALS, DHAHRAN (SA)

(21) Appl. No.: 13/760,031

(22) Filed: Feb. 5, 2013

(51) Int. Cl. B60S 9/12

(52) U.S. Cl. CPC B60S 9/12
USPC 254/423

(57) ABSTRACT

The vehicle with integral tire jacks is an automatic built-in system for lifting a vehicle in the event of a flat tire when the tire requires replacement. The system includes four jacks installed under the vehicle near each wheel. An air compressor activated and controlled by an internal control panel will provide pressure to the jacks, the control panel being provided with knobs and buttons enabling the control of a desired jack.

### BACKGROUND OF THE INVENTION

1. Field of the Invention

The present invention relates to automobile jacks, and particularly to a vehicle with integral tire jacks.

2. Description of the Related Art

The most common use of automobile jacks is to elevate one side of a car or truck for removal and replacement of a flat tire. A portable, manually operable jack matched to the specific type of vehicle is often provided with new vehicles. The operator would normally remove the jack from its storage position and position the jack under the vehicle's frame. The operator would then manually crank the jack to free the flat tire from contact with the ground. Subsequently, the operator would remove the tire using tools, such as a lug wrench or spider wrench, and replace the tire in the same manner.

Occasionally, flat tires occur during inclement weather, causing difficulty in accessing and using a portable jack to raise a flat tire. Likewise, portable jacks may be lost and are not available for service. At other times, the jack may be stored in a trunk under luggage, requiring the trunk to be unloaded. A vehicle may have a flat lowering the vehicle to such a degree that a portable jack cannot be placed under the vehicle. During a general maintenance procedure, such as tire rotation, it is often time-consuming and difficult to sequentially raise the vehicle and remove a first tire, lower the vehicle, then raise another portion of the vehicle, remove a second tire and replace it with the first tire, and then repeat the process until all of the tires have been rotated. Other uses of jacks include accessing the underside of a vehicle for such things as oil changes, as well as body work, etc.

Thus, a vehicle with integral tire jacks solving the aforementioned problems is desired.

### SUMMARY OF THE INVENTION

The vehicle with integral tire jacks is a vehicle having a control panel and system for that provides for lifting the vehicle for changing a tire or any other reason requiring access to the underside of a vehicle. The integral tire jacks include at least four pneumatic jacks, each one associated with a vehicle wheel. The integral tire jacks also include a complete control system that provides a self-contained system for lifting the vehicle with ease and safety. Confirmation buttons located in the control panel turn from red to green prior to operating the lift. Also, the system may have a flat tire detector sensor that indicates that a tire is flat. Another confirmation sensor maybe provided to detect the flat tire wheel bolt tightness and looseness prior to lifting. In addition, the controls may permit the user to start lifting by a first push on a control button, to stop lifting and hold the wheel in the elevated position by a second push on the control button, and to start lowering the vehicle by a third push on the control button. It is noted that such push button operation is similar to the operation of currently available garage door openers and the like.

The integral tire jacks provide safety features to enhance the usability of the system. First, a set of readable instructions, in the form of indicia, is provided for the user to reference and follow the proper procedures in use. In addition, the control system of the integral tire jacks provides a plurality of sensors for detecting vehicle parameters, and determines if the vehicle is ready to be lifted by the integral tire jacks. Also, an indicator provides a visual (and audio) annunciation to notify the user that the vehicle is ready to be lifted. In addition, another safety feature includes a manual brace associated with each jack for maintaining the stability of the jack, and to provide a solid member to support the vehicle in case the pneumatic jack fails.

These and other features of the present invention will become readily apparent upon further review of the following specification and drawings.

### BRIEF DESCRIPTION OF THE DRAWINGS

FIG. 1 is an environmental side view of a vehicle with integral tire jacks according to the present invention.

FIG. 2 is a partial side view of a vehicle with integral tire jacks according to the present invention.

FIG. 3 is a bottom view of a vehicle with integral tire jacks according to the present invention.

FIG. 4 is a front view of a control panel for a vehicle with integral tire jacks according to the present invention.

Similar reference characters denote corresponding features consistently throughout the attached drawings.

### DETAILED DESCRIPTION OF THE PREFERRED EMBODIMENTS

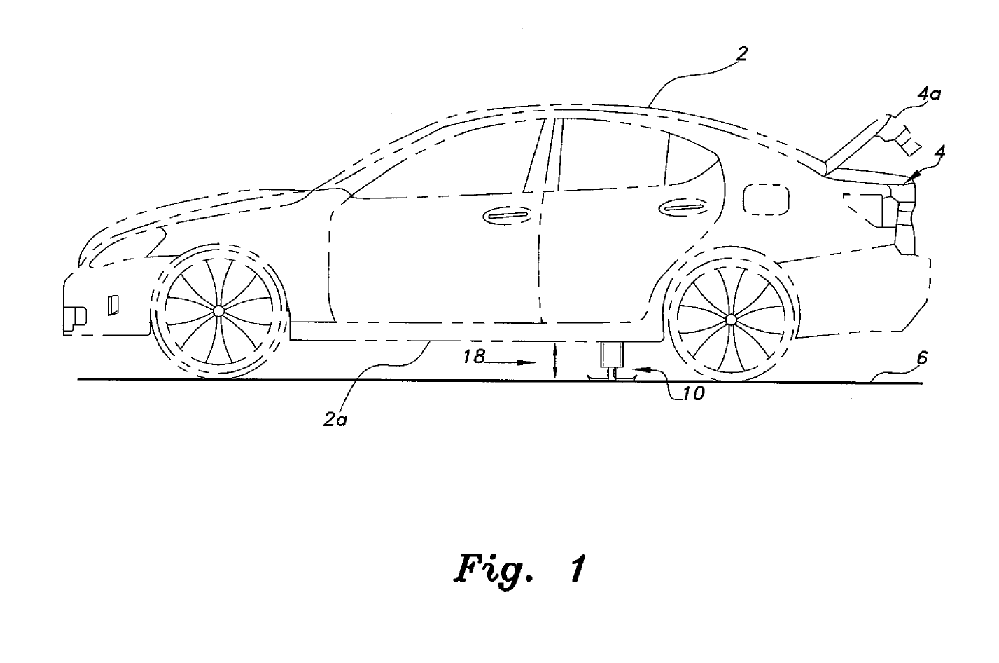

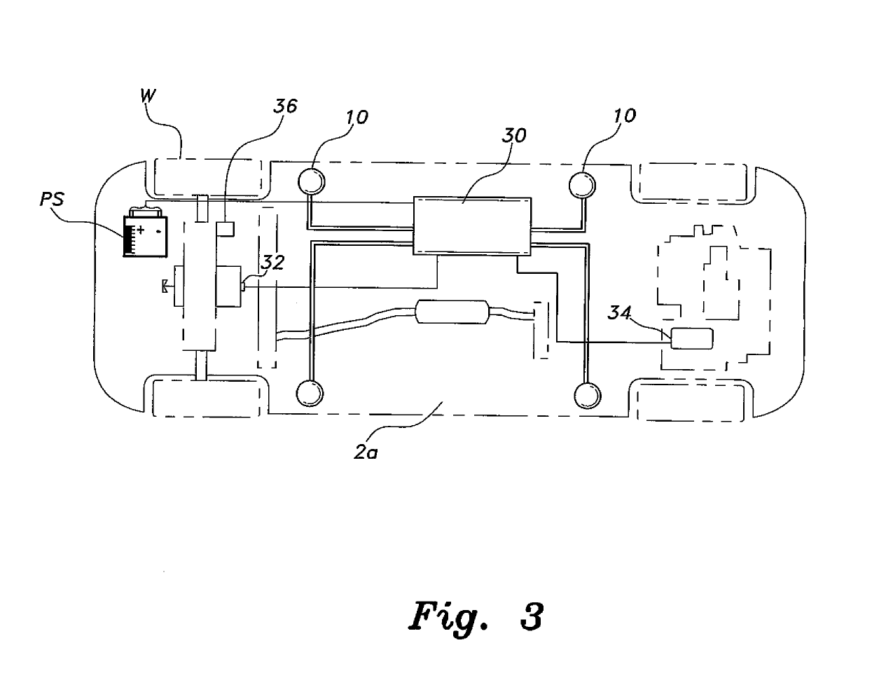

As seen in FIGS. 1 and 3, the vehicle with integral tire jacks for lifting a vehicle is a system that has a pneumatic jack 10 integrally mounted beneath a vehicle 2 near each one of the wheels. Thus, there are at least four units 10, each integrally attached to the underside 2a of a vehicle 2 near each wheel. Preferably, the units should be located between the wheels on each side of the vehicle 2. That is, the jack 10 near the rear wheel is located forward of the rear wheel, and the jack 10 associated with the front wheel is located rearward of the front wheel. The integral tire jacks 10 are extendable from the underside 2a of the vehicle 2 to raise the vehicle 2 above the ground or supporting surface 6 so that a wheel of the vehicle 2 is lifted off the ground or supporting surface 6 to a preferred distance. The lifting, and subsequent lowering, is along the directional arrows 18. The preferred distance to lift the vehicle 2 along the directional arrows 18 is on the order of two (2) inches of clearance of the wheel from the ground 6.

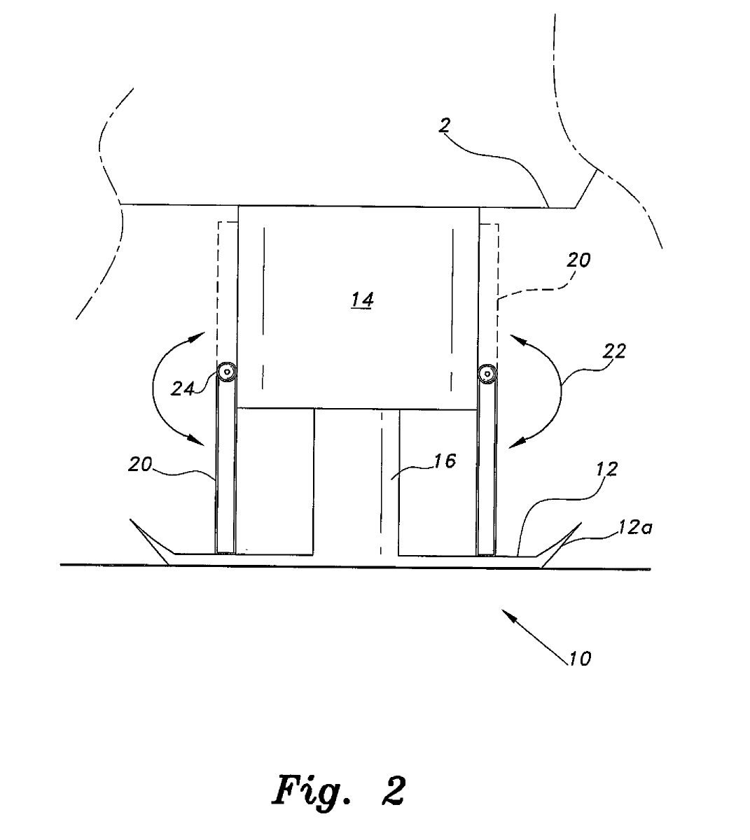

Referring to FIG. 2, each one of the pneumatic jacks 10 includes a housing 14. The housing 14 is also an outer cylinder of the jack 10. The jack 10 further includes a telescoping piston 16, which has a foot 12 for engagement with the surface 6. The foot 12 also has a housing seal 12a such that when the piston 16 of the jack 10 is in the retracted position, the housing seal 12a of the foot 12 closes the housing 14, preventing road debris from entering the cylinder housing 14 and collecting and/or causing the jack 10 to malfunction.

The foot 12 has an outer diameter greater than the housing 14, so that the seal 12a completely encloses the housing 14 when the piston 16 is in the retracted position. Additionally, the foot 12 is formed of a material having a high coefficient of friction (e.g., rubber) for increased frictional engagement with the ground or support surface 6.

As seen in FIG. 2, the jack 10 also has an additional safety feature, which is a support bar 20 pivotally attached via hinge member 24 to the housing 14. The support bars 20 are pivoted into position once the piston 16 has been extended and the foot 12 engages the ground surface 6. The support bars 20 offer additional security for the jack 10 to maintain the vehicle 2 elevated off of the ground surface 6. The support bars 20 are manually or automatically positioned and restored along the housing 14.

FIG. 3 shows that the integral jack system includes, mounted on the underside 2a of the vehicle 2, a control system that includes a compressor or pneumatic pump 30 mounted on the underside 2a of the vehicle 2 for providing pneumatic fluid (compressed air) via pneumatic lines to each of the jacks 10. The air distribution system may include pneumatic valves that independently control distribution of compressed air from the pump 30 to the jacks 10, the valves being electronically controlled and activated from the control panel 40, described below. Additionally, a plurality of sensors is provided for determining certain vehicle conditions before executing the deployment of anyone of the jacks 10. Sensor 32 detects the operating condition of the engine. Sensor 32 cooperates with the control system to ensure that the engine is off, as a safety precaution, before elevating the vehicle 2 by the jacks 10. Sensor 34 detects the condition of the parking brake of the vehicle, ensuring that the parking brake is engaged before the execution of the vehicle 2 lifting by the jacks 10. A third sensor 36 detects the state of the vehicle transmission, ensuring that the transmission of the vehicle 2 is in the ‘PARK’ position (for automatic transmissions), and/or in ‘FIRST GEAR’ (for manual transmissions).

Optionally, a fourth sensor may be provided for detecting the location of the flat tire when the tire is flat or low on pressure. This type of flat tire sensor incorporate one of the following pressure detection mechanisms: measurement of the distance from the car floor to the ground (if the measurement is less than a predetermined value, the sensor will notify the control panel and activate the red light); a fluid level, similar to mercury in a thermostat, that operates as a switch to close a circuit to generate an alarm that the tire associated therewith is low on air pressure or flat; a mechanical limit switch that deactivates an electrical circuit connection (such as a spring-biased contact on the chassis that is connected to the wheel, tie rod arm, or the like by a wire that is pulled down to trip the contact when the tire goes flat or loses enough pressure that the car is no longer level); or a pressure gauge attached to the tire that sends pressure values to the main control panel to continuously compare the measured pressure with stored threshold pressure values, which may activate the red color light next to the FR, FL, RR, and RL indicia on the control panel when the measured pressure is less than the stored threshold value.

A fifth sensor may be provided to detect the integrity of the wheel bolts on the flat tire. This sensor monitors the torque of the wheel bolts, provides an indication of when the wheel bolts on the flat tire are loose enough to remove the tire prior to lifting the wheel from the ground.

This is a further safety precaution to ensure that the vehicle 2 is stable in order to execute lifting the vehicle 2 via the jacks 10. The system is powered by a power supply PS, generally denoted as the battery of the vehicle. In addition, a further safety provision of the system extends the other three jacks to touch the ground to stabilize the vehicle while the fourth jack performs the lifting operation on the actual flat tire.

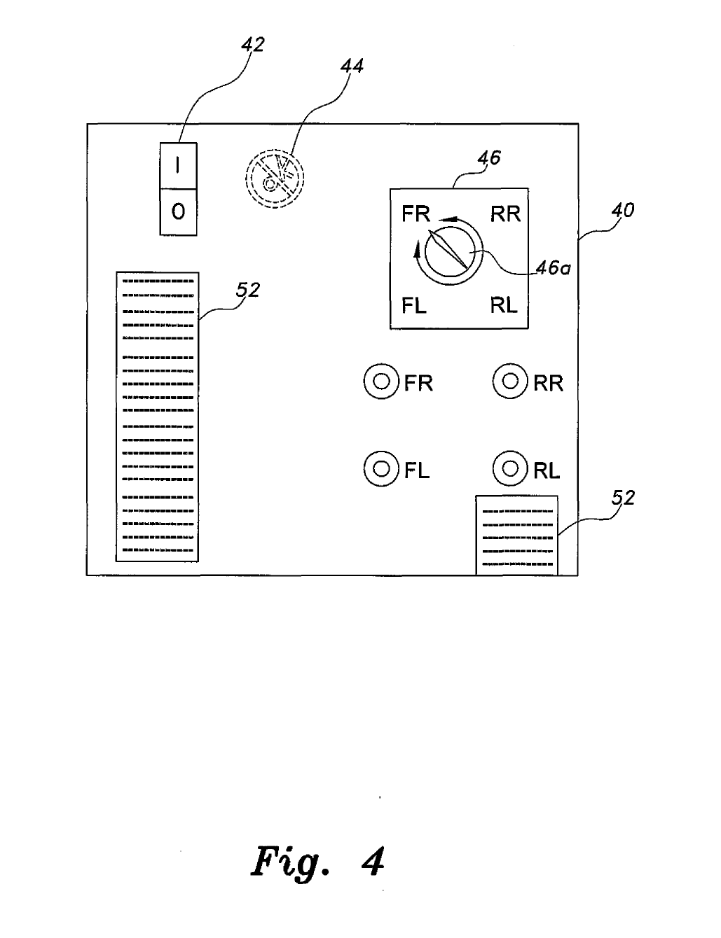

The control system has a control panel 40, as seen in FIG. 4. The control panel 40 is typically located in the trunk 4 of the vehicle 2 (see FIG. 1). The trunk 4 is accessed via the trunk lid 4a. The trunk 4 location of the control panel 40 is selected because it allows the user the opportunity to ensure all safety conditions are met, and it is conveniently located near access to the spare tire. The control panel 40 has a main ON/OFF switch 42 for actuating the control system and pneumatic pump 30. The control panel 40 also includes indicia 52 imprinted thereon (or attached by label) to provide the user with step-by-step instructions to safely use the pneumatic jacks 10. Upon activation, the sensors 32, 34, 36 report the specific sensed conditions, and an indicator lamp 44 (and/or audible annunciation) provides the user with a go ahead to use the system for lifting a wheel of vehicle 2 off the ground 6.

In use, when a flat tire is detected via the sensors, a visual indication is illuminated (or an audio indication is sounded), and the appropriate button adjacent to the FR, LR, RR and RL indicia is illuminated. For example, a visual indication of a flat front right tire would be a RED light next to the FR indicia, and, if not flat, then a GREEN light, and so on for each tire. This illumination is simultaneous for the four tires so that user will know which switch to actuate for fixing the flat tire, by selecting 46 the appropriate tire position via the knob 46a. Once a flat tire sensor (e.g., distance sensor, fluid level sensor, or mechanical limit switch, a tire pressure gauge, as described above) sends an indication to the main control panel, activation of the FR, FL, RR, and RL visual indicators by the main control panel would indicate which tire needs to be changed. Upon activation, the remainder of the various vehicle condition sensors would be used to indicate whether it was safe for the vehicle to be lifted by the jack via indicator 44.

Once receiving the go ahead indication, the user turns the selector knob 46 to the preferred wheel position to be lifted. The control system and pneumatic pump produce enough pneumatic pressure to actuate all of the jacks 10, such that each one of the jacks extends and engages the ground surface 6. The user then selects the preferred toggle switch 48 for the selected wheel (via knob 46) to select the lifting or descending (i.e., after completion of tire changing process) of the selected jack 10.

Upon completion of the task, the ON/OFF switch 42 deactivates the system, and all of the jacks 10 are returned to the retracted and closed positions, thus ensuring the safety of the user.

It is to be understood that the present invention is not limited to the embodiments described above, but encompasses any and all embodiments within the scope of the following claims.

We claim:

1. A pneumatic jack system adapted for mounting on an automobile, comprising:
at least one pneumatic jack adapted for being integrally mounted beneath an automobile near at least one of the wheels, the at least one pneumatic jack having a housing and a piston extendable from the housing, the piston having a free end and a foot attached to the free end, the foot having a diameter greater than the housing, the foot further having a ground-contacting surface having a high coefficient of friction;
a pneumatic pump adapted for mounting beneath the automobile for providing compressed air;
at least one hose line connected between the pneumatic pump and the at least one pneumatic jack; and
a control system having means for controlling the pneumatic pump to provide pneumatic fluid to the at least one pneumatic jack via the at least one hose line;
wherein the piston of the at least one pneumatic jack is extendable from beneath the automobile upon receiving compressed air from the pneumatic pump for a distance sufficient to engage the ground and raise the wheel adjacent the jack above the ground.

2. The pneumatic jack system according to claim 1, wherein the at least one jack comprises a plurality of jacks adapted for associating one of the jacks with each wheel of the automobile, and wherein the at least one hose line includes one hose line coupled between each of the one jacks and the pump.

3. The pneumatic jack system, according to claim 2, wherein the at least one jack comprises four jacks, each one of the four jacks being adapted for mounting adjacent a corresponding wheel of the automobile.

4. The pneumatic jack system for an automobile, according to claim 1, wherein the control system further comprises a plurality of condition sensors for determining safety criteria upon actuation of the system.

5. The pneumatic jack system according to claim 4, wherein the condition sensors comprise sensors for sensing engine, transmission, flat tire location, wheel bolt condition, and brake actuations.

6. The pneumatic jack system for an automobile, according to claim 5, wherein the control system comprises a control panel having indicators coupled to the condition sensors for displaying an indication of conditions sensed by the condition sensors.

7. The pneumatic jack system according to claim 6, wherein the control panel has means for activating the system and means for providing an indication that the automobile is safe to be lifted, the control panel further including instruction indicia printed thereon.

8. A vehicle with integral tire jacks, comprising:
a motor vehicle having a plurality of wheels having a ground-engaging tire mounted thereon;
a plurality of pneumatic jacks, each of the wheels having a corresponding one of the jacks mounted adjacent thereto, each of the jacks having a cylinder fixed to the vehicle and a piston extendable from the cylinder downward to a length sufficient to engage the ground and raise the corresponding tire above the ground;
a plurality of feet, each of the pistons having one of the feet mounted thereon, each of the feet having a ground-engaging surface having a high coefficient of friction, each of the feet having a diameter greater than the corresponding jack cylinder so that the feet form a seal against the cylinder when the piston is retracted;
a pneumatic pump mounted on the vehicle;
a plurality of air hose lines extending between the pump and each of the pneumatic jacks;
a control panel mounted in the vehicle, the control panel having means for independently activating a user-selected one of the pneumatic jacks;
a plurality of sensors mounted on the vehicle, the sensors including an engine sensor for sensing when the engine is off, a transmission sensor for sensing when the transmission is not in gear, flat tire sensor for locating which tire is flat, and parking brake sensor for sensing when the parking brake is on; and
a plurality of indicators mounted on the control panel, the indicators being connected to the sensors to indicate conditions sensed by the sensors.

9. The vehicle with integral tire jacks according to claim 8, wherein said feet are made from rubber.
